(19) United States
(12) Patent Application Publication
(10) Pub. No.: US 2025/0134151 A1
(43) Pub. Date: May 1, 2025

(54) EXTRUDED FLATTENED HIGH PROTEIN FOOD PIECES AND METHODS OF MAKING

(71) Applicant: GENERAL MILLS, INC., Minneapolis, MN (US)

(72) Inventors: Claire RANDOLPH, Robbinsdale, MN (US); Robert Joseph HARRISON, Nowthen, MN (US); Jeffrey T. HUBER, Robbinsdale, MN (US); Michelle MANDERFELD, Plymouth, MN (US); Sara ROSENE, New Hope, MN (US); Goeran WALTHER, Plymouth, MN (US)

(21) Appl. No.: 18/837,298

(22) PCT Filed: Feb. 14, 2023
(86) PCT No.: PCT/US2023/013005

§ 371 Date: Aug. 9, 2024

Related U.S. Application Data
(60) Provisional application No. 63/309,830, filed on Feb. 14, 2022.

(51) Int. Cl. A23L 33/19; A23J 3/22; A23J 3/26; A23L 7/117; A23L 33/185; A23P 20/20; A23P 30/20

(52) U.S. Cl. CPC A23L 33/19; A23J 3/222; A23J 3/225; A23J 3/265; A23L 7/117; A23L 33/185; A23P 20/20; A23P 30/20

(57) ABSTRACT

The present disclosure relates to high protein, ready-to-eat flattened food pieces, compositions including such food pieces, and methods of making such food pieces. The food pieces include at least 70% by dry weight protein, where the protein ingredients include a base protein blend that makes up at least 60% by dry weight of the protein ingredients. The base protein blend includes sodium caseinate and one or more of legume protein isolate, legume protein concentrate, milk protein isolate, or milk protein concentrate.

### CROSS-REFERENCE TO RELATED APPLICATIONS

This application claims the benefit of U.S. Patent Application Ser. No. 63/309,830 entitled “Extruded Flattened High Protein Food Pieces and Methods of Making” filed Feb. 14, 2022, pending. The entire content of this application is incorporated herein by reference.

### TECHNOLOGY

The present disclosure generally relates to an extruded protein product and methods of making such a product.

### BACKGROUND

High protein food products have found popularity among consumers as a way to eat nutritionally dense foods. Consumers want diverse ways to get increased protein into their diets. Thus, there is a need for new high protein food products to satisfy the increasing consumer desire for protein.

### SUMMARY

High protein, ready-to-eat food pieces and methods of making such food pieces are provided herein.

A ready-to-eat flattened food piece is provided herein having a protein content of at least 70% by dry weight of the food piece and a moisture content of about 0.5% to about 7%. The food piece includes oil in an amount of about 1% to about 8% by dry weight of the food piece and protein ingredients, where the protein ingredients include a base protein blend that comprises at least 60% by dry weight of the protein ingredients. The base protein blend consists of sodium caseinate (Na Cas) in an amount of about 10% to about 60% by dry weight of the protein ingredients; and legume protein isolate (LPI), legume protein concentrate (LPC), milk protein isolate (MPI), milk protein concentrate (MPC), or a combination thereof in an amount of about 20% to about 80% by dry weight of the protein ingredients. In some embodiments, a food piece can include soy protein isolate (SPI) in an amount of up to 55% (e.g., up to 50%) by dry weight of the protein ingredients. In some embodiments, a food piece can include milk protein isolate (MPI) is included in an amount of up to 55% (e.g., up to 50%) by dry weight of the protein ingredients.

In some embodiments, a food piece can include Na Cas in an amount of 10% to about 40% by dry weight of the protein ingredients; MPI, MPC, or a combination thereof in an amount of 20% to 50% by dry weight of the protein ingredients; and SPI, SPC, calcium caseinate (Ca Cas), or a combination thereof in an amount of about 20% to 50% by dry weight of the protein ingredients.

In some embodiments, a food piece can include Na Cas in an amount of 10% to about 40%; MPI, MPC, or a combination thereof in an amount of 25% to 45%; and SPI, SPC, Ca Cas, or a combination thereof in an amount of about 25% to 45% by dry weight of the protein ingredients.

In some embodiments, a food piece can include calcium carbonate in an amount of about 0.1% to 4% by weight of the food piece.

In some embodiments, an oil included in a food piece can comprise canola oil or corn oil.

In some embodiments, a food piece can include one or a combination of additional protein ingredients in an amount of up to 40% by weight of the protein ingredients.

In some embodiments, a food piece can include an additional ingredient in an amount of up to 15% by dry weight of the food piece.

In some embodiments, ingredients derived from grains can be included in a food piece in an amount of less than 15% by dry weight of the food piece. In some embodiments, a food piece can contain no ingredients derived from grains.

In some embodiments, a food piece can include less than 5% by weight carbohydrate. In some embodiments, a food piece can include no added carbohydrates.

A method of making a ready-to-eat flattened food piece is provided herein, where the food piece has a protein content of at least 70% by dry weight of the food piece. The method includes combining ingredients under extrusion conditions to make a composition having a protein content of at least 70% by dry weight, directing the composition through a die opening to make an extruded dough, forming the extruded dough to produce a flattened dough, and drying the flattened dough to a moisture content of about 0.5% to about 7% to produce the flattened food piece. The ingredients include oil in an amount of about 1% to about 8% by dry weight of the composition, water in an amount of about 20% to about 30% by weight of the composition, and protein ingredients including a base protein blend comprising at least 60% by dry weight of the protein ingredients, where the base protein blend consists of sodium caseinate in an amount of about 10% to about 60% by dry weight of the protein ingredients; and legume protein isolate, legume protein concentrate, milk protein isolate, milk protein concentrate, or any combination thereof in an amount of about 20% to about 80% by dry weight of the protein ingredients. The extrusion conditions include low shear and a barrel temperature of about 160° F. to about 260° F.

In some embodiments, extrusion conditions can include a barrel temperature of about 160° F. to about 260° F.

In some embodiments, extrusion conditions can include a twin screw extruder with 2 reverse or high shear elements.

In some embodiments, extrusion conditions can include a die pressure of about 600 psi to about 1500 psi, or about 650 psi to about 1400 psi.

In some embodiments, extrusion conditions can include specific mechanical energy (SME) of about 40 W*h/kg to about 80 W*h/kg.

In some embodiments, extrusion conditions can include a die temperature of about 200° F. to about 250° F.

In some embodiments, a forming step can include directing pieces of the extruded dough through a flaking mill to produce the flattened dough.

In some embodiments, a forming step can include forming the extruded dough into a continuous sheet and cutting the sheet to produce the flattened dough. In some embodiments, a continuous sheet can be a lattice. In some embodiments, a continuous sheet can be formed into shredded ropes. In some embodiments, a continuous sheet is layered with at least one other continuous sheet, and the layered sheets can be cut into pieces. Also provided herein are packaged food products comprising food pieces disclosed herein. A packaged food product can contain food pieces made according to any method provided herein.

These and various other features and advantages will be apparent from a reading of the following detailed description.

### BRIEF DESCRIPTION OF THE DRAWINGS

FIG. 1 shows pictures of embodiments (Variations 1, 2, and 4 from Example 1) that are particularly preferred in eating quality and illustrate a range of visual qualities that embodiments of a flattened food piece provided herein can exhibit.

FIG. 2 shows pictures of embodiments (Variations 3, 6, and 7 from Example 1) that are acceptable in eating quality and illustrate a range of visual qualities that embodiments of a flattened food piece provided herein can exhibit.

FIG. 3 shows a picture of flattened food pieces (Variation 5 from Example 1) that were too fragile for drying (picture is from after flaking but before drying).

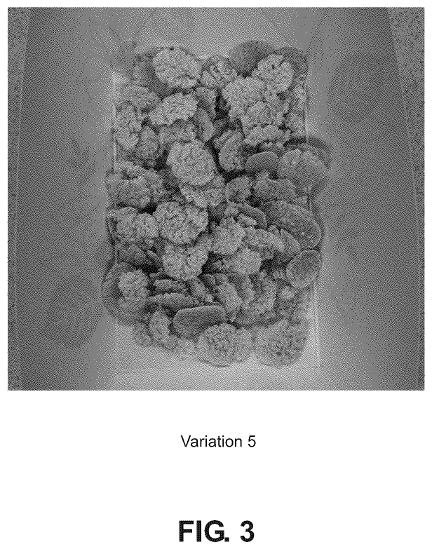

### DETAILED DESCRIPTION

Consumers continually expect an even greater variety of high protein foods that are suitable for different eating occasions. In addition, many consumers prefer to reduce carbohydrate intake. However, protein ingredients often suffer from bitter taste, astringency, and/or off-flavor/aroma, and have proven difficult to achieve a product that has a texture in the absence of carbohydrate-containing ingredients (e.g., starches) to produce a product that resembles a traditional ready-to-eat (RTE) grain-based breakfast cereal. The present application describes the discovery of high protein compositions containing little to no carbohydrate content that can be formed into a high protein, RTE food piece having a pleasant, crunchy texture resembling traditional grain-based RTE breakfast cereal, and having a pleasant or neutral flavor, even in the absence of flavorants or off-flavor maskers. Such compositions can be extruded and then further processed into a flattened form rather than maintaining a directly expanded form from extrusion.

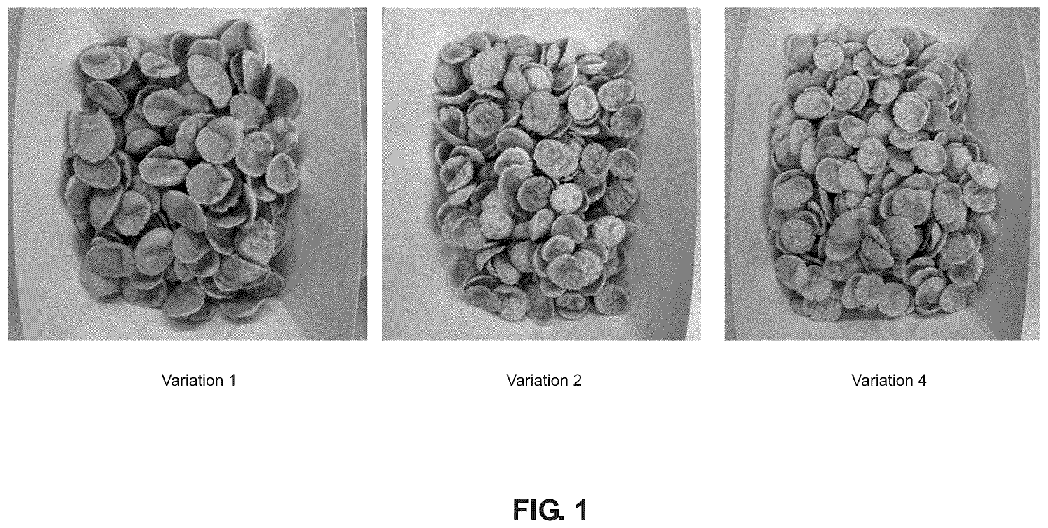

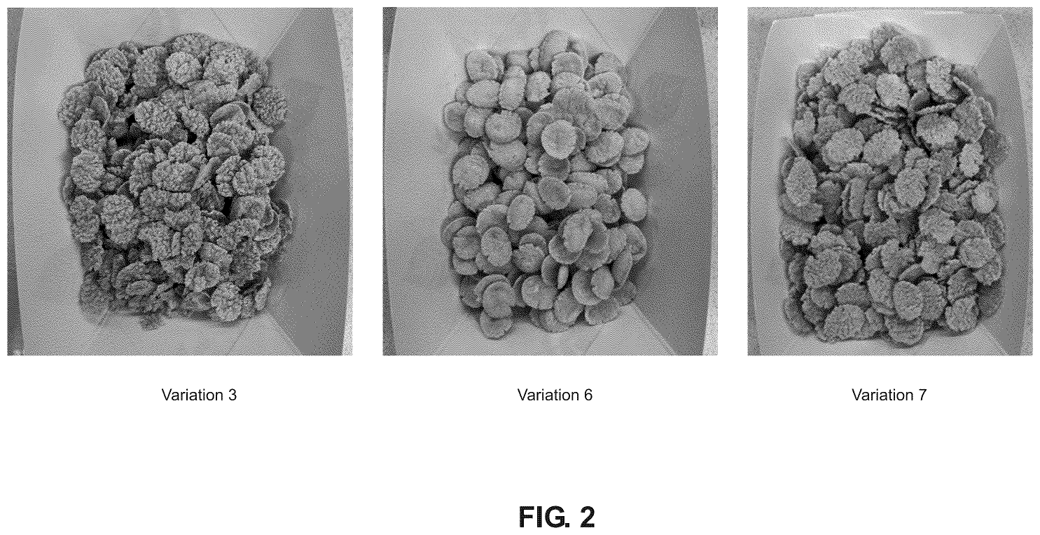

A food piece provided herein is a high protein ready-to-eat flattened food piece. As used herein, “flattened piece” refers to a food piece that has a generally flattened form, although a flattened food piece need not be planar. For example, in many cases, a flattened food piece can have a curved, curled, wavy, rough, or pillowed appearance due to one or more process steps (e.g., flaking, sheeting, shredding, forming, drying, toasting, or the like) following extrusion. See, for example, FIGS. 1 and 2. Flattened food pieces can include, for example, a flake (e.g., resembling Wheaties™ brand breakfast cereal, Total™ brand breakfast cereal, or FIG. 2, Variation 3 and Variation 7), a sheet (e.g., resembling a product, such as Cinnamon Toast Crunch™ brand breakfast cereal), a single sheet pillow (e.g., resembling an oyster cracker), a shredded pillow (e.g., resembling shredded wheat cereal), or a multi-sheet pillow (e.g., resembling Chex™ brand or Shreddies™ breakfast cereal).

As used herein, the term “high protein” refers to a food piece that includes protein in an amount of at least 70% (e.g., at least 80%, at least 84%, or about 85-90%) by dry weight of the food piece. As used herein, the term “ready-to-eat” (“RTE”) refers to a food that does not require further cooking or preparation to be suitable and safe for consumption. A food piece provided herein is typically also shelf stable at room temperature for at least 3 months (e.g., at least 6 months, or 8 months to 1 year) without significant negative impact on texture, structure, or flavor when stored in appropriate packaging. A food piece provided herein can also be suitably coated, or it can be used in other products, such as dry snacks, snack blends, cold-formed or baked snack bars or clusters.

A food piece provided herein includes a base protein blend that includes sodium caseinate (“Na Cas”) combined with a legume protein concentrate (“LPC”), a legume protein isolate (“LPI”), a milk protein concentrate (“MPC”), a milk protein isolate (“MPI”), or Na Cas combined with any combination of LPC, LPI, MPC, and MPI. Surprisingly, it was discovered that a food piece that includes a base protein blend in an amount of at least 60% (e.g., about 65% to 100%, or about 75% to 100%) by dry weight of protein ingredient content has a better texture and flavor than any one of Na Cas, MPI, MPC, LPC, or LPI alone. That is, a food piece provided herein has noticeably less pronounced dairy flavor than MPI, MPC, or Na Cas, alone and noticeably less pronounced legume flavor than LPC or LPI alone, resulting in a pleasant, or at least neutral flavor, even in the absence of flavorants or off-flavor maskers. Even if Na Cas is combined with one or both of MPI or MPC, in the absence of any legume protein source, it was discovered that dairy flavor was still reduced relative to any of Na Cas, MPI, or MPC alone. In addition, while it was found that none of Na Cas, MPI, MPC, legume protein concentrate, or legume protein isolate alone could be extruded to form a dough that could be flattened and dried to form a food piece that produced a stable structure or suitable texture, the below-described combinations of protein ingredients produced both stable structure and suitable texture in a flattened food piece.

As used herein, LPC and LPI can be derived from any appropriate legume, such as soybean, pea, chickpea, bean, lentil, or the like.

Sodium caseinate is included in a food piece in an amount of about 10% to about 60% (e.g., about 15% to about 55%, or about 25% to about 40%) by dry weight of protein ingredients. In some cases, flattened food pieces including Na Cas on the high end of the range can have a pillowed appearance following high temperature drying and toasting. Na Cas extruded alone can result in extruder clogging, and including Na Cas in amounts of more than 50% by dry weight of protein ingredients results in a texture that can be described as “tooth packing,” as well as increase the risk of producing products during extrusion with too much browning or that are burned or scorched. Less than 10% Na Cas by dry weight of protein ingredients results in food pieces that are denser and harder than desired.

LPC, LPI, MPC, MPI, or combination thereof is included in a food piece provided herein in an amount of about 20% to about 80% (e.g., about 25% to about 50%, or about 25% to about 40%) by dry weight of protein ingredients. In some embodiments a food piece provided herein can include LPC, LPI, or combination thereof in an amount of about 8% to about 50% (e.g., 20% to about 45%, or about 25% to about 35%) by dry weight of the protein ingredients and a MPC, MPI, or combination thereof in an amount of about 20% to about 50% (e.g., 25% to about 45%, or about 25% to about 35%) by dry weight of the protein ingredients.

LPC and LPI can contribute to a stable structure, desirable texture, and neutral or pleasing flavor when combined with Na Cas (with or without MPC and/or MPI), and can advantageously reduce cost of a food piece provided herein. Flattened food pieces formed as flakes that include LPI or LPC at the higher end of the range tend to have an appearance that is wrinkly, and resemble Wheaties™ brand breakfast cereal in form. LPC or LPI alone can be extruded, but some LPI and LPC were found to produce a dense pellet that is not sufficiently soft or flexible enough to be further formed into a flattened dough without cracking or crumbling. In addition, increasing amounts of a LPI, especially soy protein isolate (“SPI”), can impact flavor, with around 33% SPI by dry weight of the protein ingredients starting to impact flavor. Although levels of LPI (e.g., SPI) can be included in amounts up to 80% by dry weight of the protein ingredients while still making an acceptable product, amounts of about 20% to about 40% by dry weight of the protein ingredients are more preferred to limit the impact on flavor. Similarly, combinations of LPI and LPC in increasing amounts can start to impact eating quality. For example, some embodiments of food pieces that contain a total soy protein ingredient content (i.e., SPI, SPC, or combinations thereof) in an amount of around 50-55% by dry weight protein ingredient content begin to exhibit dryness in the mouth, a mealy texture, and a beany flavor. As a result, it is preferred that total soy protein ingredient content be included at less than 60% by dry weight of the protein ingredients.

MPC and MPI can also contribute to a stable structure, desirable texture, including some crunchiness, and neutral or pleasing flavor of a food piece provided herein when combined with Na Cas (with or without LPC and/or LPI). MPC and MPI can be extruded alone, but they generally form dense pellets with a glassy, sandy texture. In addition, amounts of MPC and/or MPI greater than 80% by dry weight of the protein ingredients results in a noticeable dairy flavor and reduced structural stability.

One or a combination of additional protein ingredients, such as calcium caseinate, acid casein, whey protein, wheat protein, can be included in a food piece provided herein in a total amount of up to 40% by dry weight of protein ingredients. Calcium caseinate can be included in an amount of up to 30% (e.g., up to about 25%) by dry weight of protein ingredients. In some embodiments, additional protein ingredients other than calcium caseinate can be included in a total amount of up to 25% (up to 20%, or up to 18%) by dry weight of protein ingredients. More than 25% total additional protein ingredients (other than calcium caseinate) can cause effects such as poor texture, extrusion difficulty, difficulty in forming into a flattened dough, and/or undesirable flavor. Calcium caseinate (“Ca Cas”) in amounts of up to 30% by dry weight of protein ingredients can contribute to a crunchy texture. Food pieces with a protein ingredient content comprising Na Cas+SPI and/or SPC+MPI at a ratio of about 1:1:1 or a protein ingredient content comprising Na Cas+SPC and/or SPI+MPI+Ca Cas at a ratio of about 1:1:1:1 produce particularly good results.

Protein ingredient content of some embodiments of a food piece provided herein that have particularly good texture, structure, and flavor, are provided in Table 1, with the percentages reflecting the amount by dry weight of the protein ingredients.

TABLE 1

| | | MPC, MPI, | LPC, LPI, | | | | |
|---|---|---|---|---|---|---|---|
| | Na | or any | or any | Ca | Wheat | Whey | Other |
| Embodiment | Cas | combination | combination | Cas | protein | protein | protein |
| 1 | 25- | 25-35% | 8-35% | 0- | 0-15% | 0-20% | 0-25% |
| | 35% | | | 25% | | | |
| 2 | 20- | 20-35% | 20-35% | 10- | 0-15% | 0-20% | 0-25% |
| | 35% | | | 25% | | | |
| 3 | 30- | 30-35% | 30-35% | 0% | 0% | 0% | 0% |
| | 35% | | | | | | |
| 4 | 20- | 20-30% | 20-30% | 20- | 0% | 0% | 0% |
| | 30% | | | 30% | | | |

As used herein, the term “concentrate” when referring to a protein ingredient refers to an ingredient that includes at least 60% (e.g., at least 70%, or at least 80%) protein by dry weight. For example, a milk protein concentrate is typically about 80% to 90% protein by dry weight; a soy protein concentrate is typically about 65% to about 90% protein by dry weight. While commercially available pea protein ingredients that are labeled as “pea protein concentrate” can have a protein concentration of about 40% to about 60% by dry weight, as used herein, a pea protein ingredient having a protein content of at least 60% by dry weight is considered to be a concentrate suitable for use in a food piece. As used herein, the term “isolate” when referring to a protein ingredient refers to an ingredient that includes at least 75% (e.g., at least 80%, or at least 90%) protein by dry weight. For example, a milk protein isolate is typically about 90% to 94% protein by dry weight; a soy protein isolate is typically at least about 90% protein by dry weight; a pea protein isolate is typically about 75% to about 90% protein by dry weight.

In some embodiments, calcium carbonate (CaCO₃) can be included in an amount of up to 5% (e.g., about 0.1% to about 4%, or about 1%) by dry weight of a food piece. While good product can be made without any CaCO₃, CaCO₃ can contribute to a desired density, amounts of from about 1.5% to about 4% resulting in a larger quantity of smaller bubbles within the extruded food piece to produce flattened food pieces that are on the denser end of the preferred range. In some cases, inclusion of calcium carbonate can be used to alter the appearance of a flattened food piece from an appearance that is smoother with increasing levels of calcium carbonate to an appearance that is more wrinkly (e.g., resembling Wheaties™ brand breakfast cereal) with decreasing levels or no calcium carbonate included. In addition, in some cases, a flattened food piece can have a more concave or curved appearance with increasing levels of calcium carbonate, while a flattened food piece can have a more flattened appearance with decreasing levels or no calcium carbonate.

In some embodiments, oil (e.g., canola oil, corn oil, olive oil, soy oil, sunflower oil, and the like, or any combination thereof) in an amount of up to about 9% (e.g., 1% to about 8%, or 2% to about 6%) by dry weight of a food piece. An oil to be included in a composition can be selected based on, for example, nutritional profile, compatibility with extrusion process and/or equipment, texture and/or mouthfeel imparted to a food piece, and/or price. Generally, an oil can contribute to an improved flavor, especially when LPC and/or LPI are included at the higher end of their ranges. In addition, oil can increase tenderness and/or reduce glassiness in a food piece.

Additional optional ingredients can be included in an amount of up to 15% (e.g., up to 12%, or up to 10%) by dry weight of a food piece. For example, bulking agents, such as starches, flours, and/or fiber can be included to modify texture, add nutritional value, contribute to structure and/or reduce cost; gums and/or hydrocolloids can be included to prevent overnucleation during extrusion, contribute to structure, and/or contribute to a desired texture; a sweetener (e.g., sugar, sugar alcohol, high potency sweetener, or the like) can be included to contribute to flavor/sweetness and/or structure or texture; colorants and/or flavorants to provide a desired appearance or flavor.

In some embodiments, a food piece provided herein can contain grain-based ingredients in an amount of less than 15% (e.g., less than 10%, or less than 5%) by dry weight of the food piece. As used herein, the term “grain-based” refers to an ingredient, such as a flour, maltodextrin, or starch, derived from grain, such as corn, wheat, rice, or oat. In some embodiments, a food piece provided herein can contain no grain-based ingredients.

In some embodiments, a food piece provided herein can have a total carbohydrate content of less than 5% (e.g., less than 3%) by dry weight.

In some embodiments, a food piece provided herein can contain no added carbohydrates. As used herein, the term “added carbohydrate” refers to a carbohydrate ingredient that is included in a food piece that is not a native component of a protein ingredient included in a food piece. For example, starches, fiber, lactose, or other sugars that may be natively found in MPI, MPC, Na Cas, Ca Cas, LPC, or LPI are not considered an added carbohydrate. However, starches from other sources (e.g., tapioca starch, corn starch, and the like), fibers from other sources (e.g., grain bran, non-digestive oligosaccharides, inulin, digestive resistant maltodextrins, soluble corn fiber, and the like), sugars from other sources (e.g., honey, table sugar, and the like) that are added to a food piece would be considered added carbohydrates.

Different forms of a flattened food piece provided herein can have different bulk densities. In some embodiments, a flattened food piece provided herein can have a bulk density of from about 150 to about 350 (e.g., about 160 to about 320) g/100 cubic inches, depending on the formulation. For example, some embodiments of a flattened food piece including Na Cas, SPI, and MPI each at about 33% by dry weight of the protein ingredients content can have a bulk density of about 150 to about 200 (e.g., about 160-190, or about 165 to about 185) g/100 cubic inches. In another example, some embodiments of a flattened food piece including MPI in an amount of about 50% by dry weight of protein ingredients, and Na Cas and SPI each at about 25% by dry weight of protein ingredients can have a bulk density of about 210 to about 250 (e.g., about 220 to about 240) g/100 cubic inches. In another example, some embodiments of a flattened food piece including SPI in an amount of about 50% by dry weight of protein ingredients, and Na Cas and MPI each at about 25% by dry weight of protein ingredients can have a bulk density of about 210 to about 280 (e.g., about 220 to about 270) g/100 cubic inches. In another example, some embodiments of a flattened food piece including Na Cas in an amount of about 50% by dry weight of protein ingredients, and MPI and SPI each at about 25% by dry weight of protein ingredients can have a bulk density of about 220 to about 320 (e.g., about 240 to about 300) g/100 cubic inches.

Generally, a food piece provided herein has a texture that is pleasant for eating, and resembles a grain-based flattened food piece. In addition, a flattened food piece provided herein should have sufficient sturdiness, so that it does not readily crumble during processing, packaging, and shelf life.

A food piece can optionally be coated with, e.g., a carbohydrate-based, sugar alcohol-based, or fat-based coating. However, the description above with respect to ingredient content does not take into account a coating. A coating can contribute to appearance, color, flavor, sweetness, texture, and the like. In some cases, a coating can contribute other attributes, such as increased bowl life for a RTE cereal.

A method provided herein includes processing a composition provided herein under extrusion conditions to produce an extruded dough, followed by forming the extruded dough to produce a flattened dough, and then drying the flattened dough to form a flattened food piece. As used herein, the term “extrusion conditions” refers to subjecting a composition to heat, pressure, and shear in an extruder (e.g., single screw extruder, twin screw extruder, triple screw extruder, ring extruder, or the like). For example, a co-rotating, intermeshing, twin screw extruder can be used in a method provided herein. Manufacturers for co-rotating twin screw extruders include, for example, Coperion, Wenger, Clextral, Berstorff, APV, Baker Perkins, Buhler, and Leistritz.

A composition suitable for extrusion in a method provided herein includes a moisture content of from about 20% to about 30% (e.g., about 22% to about 28%, or about 23% to about 27%) by weight of the composition. Composition moisture contents at the lower end of the range can benefit compositions that include plant protein (e.g., soy protein, wheat protein, and the like), while moisture at the higher end of the range can benefit compositions that do not include plant protein.

A composition is typically made in a continuous fashion by feeding ingredients into an extruder during an extrusion process. In some embodiments, dry ingredients can be combined to produce a dry mix prior to being combined with water or other aqueous ingredients and oil to produce a composition suitable for extrusion. In some embodiments, dry ingredients and a portion of water can be combined in a preconditioner prior to being fed into an extruder.

A composition provided herein should be extruded under low shear conditions to prevent over shearing, which results in burning the ingredients. Reverse and/or high shear elements may still contribute to ensuring that a food piece provided herein is fully cooked and suitable to be ready-to-eat. However, much lower temperatures (e.g., barrel temperature 260° F. or lower) than typically used for extruding grain-based RTE cereal can surprisingly achieve an extruded dough with sufficient pliability and cohesiveness to be readily formed into a flattened form and then dried to produce a high protein RTE flattened food piece. For example, in a 7 barrel, 42 mm twin screw extruder being run at about 300 rpm, with a feed rate of 1000 g/minute dry feed and a die temperature of about 180° F., 1-3 reverse elements or high shear elements (e.g., 2 reverse or high shear elements) works well.

Although a composition used to make a flattened food piece herein can experience some expansion upon extrusion, further processing, such as high temperature drying and/or toasting, is typically responsible for any expansion or puffing seen in the final product, rather than puffing as a result of direct expansion from extrusion.

In some embodiments, extrusion conditions can comprise a barrel temperature of about 160° F. to about 260° F. (e.g., from about 170° F. to about 250° F., or from about 180° F. to about 245° F.). As used herein, the term “barrel temperature” refers to the maximum temperature of a heated barrel of an extruder. In some embodiments, extrusion conditions can comprise a die temperature of about 180° F. to about 250° F. (e.g., from about 190° F. to about 240° F., or from about 200° F. to about 230° F.). As used herein, the term “die temperature” refers to the maximum temperature of a composition inside a die assembly of an extruder. In some embodiments, extrusion conditions can comprise a die pressure of about 600 psi to about 1500 psi (e.g., from about 650 psi to about 1400 psi, or about 700 psi to about 1350 psi). As used herein, the term “die pressure” refers to the maximum pressure measured in the die just before the die exit. In some embodiments, extrusion conditions can comprise a specific mechanical energy (SME) of about 40 W*h/kg to about 80 w*h/kg (e.g., about 50 to about 75 W*h/kg, or about 60 to about 70 W*h/kg). In some embodiments, extrusion conditions can comprise a screw speed of about 220 to about 360 (e.g., about 250 to about 340, or about 280 to about 320) rpm. In some embodiments, e.g., using a Buhler 42 mm twin screw extruder, extrusion conditions can comprise a dry feed rate of about 800 to about 1200 (e.g., about 1000) g/minute, with a water feed rate sufficient to achieve the desired moisture content of a composition (e.g., about 20% to about 30%), and oil feed rate sufficient to achieve the desired oil content in the food piece (e.g., up to 9% by dry weight).

A composition is extruded through a die to form an extruded dough. A die opening can be any appropriate size or geometry (e.g., circular, a slit, or an irregular opening), and if multiple openings are included in an extruder die assembly, each opening need not have the same size or geometry.

An extruded dough can be formed to make a flattened dough using any appropriate forming process. For example, an extruded dough can be cut into pieces that are then passed between rollers to form a flattened dough to make a flake type food piece. In another example, an extruded dough can be sheeted to form a continuous flattened dough sheet, and cut into pieces to make a sheet type or single-sheet pillow type food piece. In another example, an extruded dough can be sheeted and then layered and cut into pieces to make a multi-sheet pillow type food piece. A flattened dough can be formed into any desired shape and embellished as desired. For example, a flattened dough that has been sheeted can be cut into pieces of any geometry (e.g., circles, squares, flowers, stars, and the like). In another example, an extruded dough can be formed into a continuous lattice type sheet and cut into pieces. In another example, an extruded dough can be formed into shredded ropes, and the shredded ropes can be layered and cut into pillows that resemble a shredded wheat type product. In yet another example, a die for producing an extruded dough can be selected to produce an irregularly shaped flake when pressed between rollers.

In some embodiments, extruded food pieces can have average weight per piece of about 0.1 to about 0.14 (e.g., about 0.11 to about 0.13, or about 0.12 to about 0.125) g. However, the size of a food piece can be adjusted for the desired use of the food piece or to provide a manufacturing advantage. For example, the size of a food piece can be adjusted to provide a desired size for eating as a stand-alone RTE breakfast cereal, or for use as a component in a snack bar or snack mix. In another example, the size of a food piece can be adjusted to result in a desired drying time during manufacturing. Piece size can be adjusted using known methods, such as die size and/or die shape selection, rate of extrusion, and/or cutter speed.

In some embodiments, a food piece can be dried to a moisture content of less than 8% (e.g., less than 7%, or about 0.5% to about 6%) to produce dried food pieces. Drying can be performed using any suitable method and equipment, such as a fluidized bed dryer. In some embodiments, drying can be performed in two steps, such as a puffing step and a toasting step. Suitable temperatures for drying can range from about 200° F. to about 500° F. (e.g., about 230° F. to about 450° F., or about 250° F. to about 400° F.).

In some embodiments, food pieces provided herein can be packaged and sold as a food product without any other components. Such packaged food pieces can be intended to be eaten as a food product alone or in combination with other food products. For example, food pieces can be packaged and sold as a stand-alone snack, a stand-alone RTE breakfast cereal, or as part of a snack or RTE breakfast cereal along with other components, such as nuts, seeds, dried fruits, other extruded food pieces, and the like. In some embodiments, a food piece can be adhered with one or more edible components, such as another food piece, nut pieces, fresh or dried fruit pieces, seeds, coconut, grain, and the like, to form a cluster or bar. A food piece and one or more edible components can be adhered to each other using any appropriate method and ingredients (e.g., edible binders and the like). For example, a cluster can be produced using a combination of a food piece and rolled oats adhered using a honey-based binder or slurry. Clusters can be provided as a food product alone or as part of a food product, such as a snack mix, ready to eat cereal, or oatmeal mix.

It is to be understood that food pieces provided herein can be used for either sweet or savory applications in food. Food pieces disclosed herein can provide a benefit of being a high protein stand-alone food product or provide added protein in combination with other components in food products while also providing an improved texture and flavor over other known high protein pieces.

### EXAMPLES

### Example 1

Food pieces were made according to the following procedure. Ingredients by total weight percentage are in Table 2. The dry ingredients for each variation were mixed in a single batch and fed into a Buhler 42 twin screw extruder fit with a single round 0.159 inch diameter die. The dry ingredients for each variation were fed at a rate of 1000 g/min. Actual temperatures within each barrel varied by up to 10° F. from the set point. The flaking mill was run at 1000 rpm with a 0.021 inch gap. Sodium caseinate (Na Cas) had a protein content of about 90% by dry weight. Soy protein isolate (SPI) had a protein content of about 90% by dry weight. Milk protein isolate (MPI) had a protein content of about 90% by dry weight and a lactose content of about 1%. Calcium caseinate (Ca Cas) had a protein content of about 94% by dry weight. Canola oil was used as the oil. Table 2 also scores each variation as being unacceptable (score of 1) or acceptable, with a score of 2 being least preferred and a score of 4 being most preferred. Scores were based on eating experience (texture, flavor, astringency).

Variation 1: Barrel 1 was at ambient temperature, barrel 2 was set at 110° F., barrel 3 was set at 180° F., barrel 4 was set at 225° F., barrels 5 and 6 were set at 230° F., and barrel 7 was set at 200° F. The die temperature at the extruder exit was about 219° F. Water was added at the second barrel section at a rate of 350 g/min, and canola oil was added at the second barrel section at a rate of 50 g/min. The product was processed at a screw speed of 300 RPM (revolutions per minute) using a screw configuration containing 2 reverse elements. The resulting torque on the system was 26.8%, yielding an SME of 61 W-Hr/Kg. With a die pressure of 1000 psi, the ropes were face cut into spherical pellets. Product samples were flattened in a flaking mill, and then dried in a zone controlled fluidized bed dryer, puffing at 420° F. and toasting at 360° F., for a total residence time of about 2-4 minutes, resulting in a final product moisture of 0.91%. The dried product yielded a bulk density of 177 g/100 in³.

The protein content of Variation 1 was calculated to be about 85% by dry weight.

Variation 2: Barrel 1 was at ambient temperature, barrel 2 was set at 100° F., barrel 3 was set at 180° F., barrel 4 was set at 225° F., barrels 5 and 6 were set at 230° F., and barrel 7 was set at 200° F. The die temperature at the extruder exit was 220° F. Water was added at the second barrel section at a rate of 350 g/min and canola oil was added at the second barrel section at a rate of 50 g/min. The product was processed at a screw speed of 300 RPM (revolutions per minute) using a screw configuration containing 2 reverse elements. The resulting torque on the system was 26%, yielding an SME of 71 W-Hr/Kg. With a die pressure of 987 psi, the ropes were face cut into spherical pellets. Product samples were flattened in a flaking mill, and then dried in a zone controlled fluidized bed dryer, puffing at 420° F. and toasting at 360° F., for a total residence time of 2-4 minutes, resulting in a final product moisture of 1.1%. The dried product yielded a bulk density of 228 g/100 in³.

The final dried food piece for Variation 2 was calculated to contain about 87% protein.

Variation 3: Barrel 1 was at ambient temperature, barrel 2 was set at 100° F., barrel 3 was set at 180° F., barrel 4 was set at 225° F., barrels 5 and 6 were set at 230° F., and barrel 7 was set at 200° F. The die temperature at the extruder exit was 207° F. Water was added at the second barrel section at a rate of 300 g/min, and canola oil was added at the second barrel section at a rate of 50 g/min. The product was processed at a screw speed of 300 RPM (revolutions per minute) using a screw configuration containing 2 reverse elements. The resulting torque on the system was 22%, yielding an SME of 63 W-Hr/Kg. With a die pressure of 1277 psi, the ropes were face cut into spherical pellets. Product samples were flattened in a flaking mill, and then dried in a zone controlled fluidized bed dryer, puffing at 420° F. and toasting at 360° F., for a total residence time of 2-4 minutes, resulting in a final product moisture of 1.24%. The dried product yielded a bulk density of 250 g/100 in³.

The final dried food piece for variation 3 was calculated to contain about 87% protein by dry weight.

Variation 4: Barrel 1 was at ambient temperature, barrel 2 was set at 100° F., barrel 3 was set at 180° F., barrel 4 was set at 225° F., barrels 5 and 6 were set at 230° F., and barrel 7 was set at 200° F. The die temperature at the extruder exit was 216° F. Water was added at the second barrel section at a rate of 350 g/min, and canola oil was added at the second barrel section at a rate of 50 g/min. The product was processed at a screw speed of 300 RPM (revolutions per minute) using a screw configuration containing 2 reverse elements. The resulting torque on the system was 25%, yielding an SME of 67 W-Hr/Kg. With a die pressure of 765 psi, the ropes were face cut into spherical pellets. Product samples were flattened in a flaking mill, and then dried in a zone controlled fluidized bed dryer, puffing at 420° F. and toasting at 360° F., for a total residence time of 2-4 minutes, resulting in a final product moisture of 2.4%. The dried product yielded a bulk density of 276 g/100 in³.

The final dried food piece for variation 4 was calculated to contain about 87% protein by dry weight.

Variation 5: Barrel 1 was at ambient temperature, barrel 2 was set at 100° F., barrel 3 was set at 180° F., barrel 4 was set at 225° F., barrels 5 and 6 were set at 230° F., and barrel 7 was set at 200° F. The die temperature at the extruder exit was 215° F. Water was added at the second barrel section at a rate of 250 g/min, and canola oil was added to the second barrel section at a rate of 80 g/min. The product was processed at a screw speed of 300 RPM (revolutions per minute) using a screw configuration containing 2 reverse elements. The resulting torque on the system was 27%, yielding an SME of 62 W-Hr/Kg. With a die pressure of 1300 psi, the ropes were face cut into spherical pellets. Upon processing this sample through the flaking mill, the resulting flakes were very delicate, making it difficult to dry. They had a light, short texture that crumbled when touched. A small portion was put in a dryer and it disintegrated.

Variation 6: Barrel 1 was at ambient temperature, barrel 2 was set at 100° F., barrel 3 was set at 180° F., barrel 4 was set at 225° F., barrels 5 and 6 were set at 230° F., and barrel 7 was set at 200° F. The die temperature at the extruder exit was 214° F. Water was added at the second barrel section at a rate of 380 g/min, and canola oil was added to the second barrel section at a rate of 10 g/min. The product was processed at a screw speed of 300 RPM (revolutions per minute) using a screw configuration containing 2 reverse elements. The resulting torque on the system was 25%, yielding an SME of 56W-Hr/Kg. With a die pressure of 752 psi, the ropes were face cut into spherical pellets. Product samples were flattened in a flaking mill, and then dried in a zone controlled fluidized bed dryer, puffing at 420° F. and toasting at 360° F., for a total residence time of 2-4 minutes, resulting in a final product moisture of 5.8%. The dried product yielded a bulk density of 324 g/100 in³.

The final dried food piece for variation 6 was calculated to contain about 89% protein by dry weight.

Variation 7: Barrel 1 was at ambient temperature, barrel 2 was set at 100° F., barrel 3 was set at 180° F., barrel 4 was set at 225° F., barrels 5 and 6 were set at 230° F., and barrel 7 was set at 200° F. The die temperature at the extruder exit was 222° F. Water was added at the second barrel section at a rate of 300 g/min, and canola oil was added at the second barrel section at a rate of 50 g/min. The product was processed at a screw speed of 300 RPM (revolutions per minute) using a screw configuration containing 2 reverse elements. The resulting torque on the system was 27%, yielding an SME of 63 W-Hr/Kg. With a die pressure of 1038 psi, the ropes were face cut into spherical pellets. Product samples were flattened in a flaking mill, and then dried in a zone controlled fluidized bed dryer, puffing at 420° F. and toasting at 360° F., for a total residence time of 2-4 minutes, resulting in a final product moisture of 1.9%. The dried product yielded a bulk density of 211 g/100 in³.

The final dried food piece for variation 7 was calculated to contain about 86% protein by dry weight.

TABLE 2

| | Na | | | | | | |
|---|---|---|---|---|---|---|---|
| Variation | Cas | SPI | MPI | Water | Oil | CaCO₃ | Score |
| 1 | 23% | 23% | 23% | 24% | 3.5% | 0.7% | 4 |
| 2 | 18% | 18% | 35% | 24% | 3.5% | 0.7% | 3 |
| 3 | 19% | 37% | 19% | 22% | 3.7% | 0.7% | 2 |
| 4 | 35% | 18% | 18% | 24% | 3.5% | 0.7% | 3 |
| 5 | 25% | 25% | 25% | 19% | 6% | 0.8% | 1 |
| 6 | 24% | 24% | 24% | 27% | 0.7% | 0.7% | 2 |
| 7 | 24% | 24% | 24% | 22% | 3.7% | 0% | 2 |

The implementations described above and other implementations are within the scope of the following claims. One skilled in the art will appreciate that the present disclosure can be practiced with embodiments other than those disclosed. The disclosed embodiments are presented for purposes of illustration and not limitation.

1. A ready-to-eat flattened food piece having a crunchy texture and a protein content of at least 70% by dry weight of the food piece, a moisture content of about 0.5% to about 7%, and comprising:
a. protein ingredients, the protein ingredients including a base protein blend that comprises at least 60% by dry weight of the protein ingredients, the base protein blend consisting of:
1) sodium caseinate (Na Cas) in an amount of about 10% to about 40% by dry weight of the protein ingredients; and
2) milk protein isolate (MPI), milk protein concentrate (MPC), or a combination thereof in an amount of about 20% to about 50% by dry weight of the protein ingredients; and
3) legume protein isolate (LPI), legume protein concentrate (LPC), calcium caseinate (CaCas), or a combination thereof in an amount of about 20% to about 50% by dry weight of the protein ingredients; and
b. oil in an amount of about 1% to about 8% by dry weight of the food piece.

2. (canceled)

3. The food piece of claim 1, wherein the food piece comprises:
a. Na Cas in an amount of 10% to about 40% by dry weight of the protein ingredients,
b. MPI, MPC, or a combination thereof in an amount of 20% to 50% by dry weight of the protein ingredients, and
c. soy protein isolate (SPI), soy protein concentrate (SPC), calcium caseinate (Ca Cas), or a combination thereof in an amount of about 20% to 50% by dry weight of the protein ingredients.

4. The food piece of claim 3, wherein the food piece comprises:
a. Na Cas in an amount of 10% to about 40%,
b. MPI, MPC, or a combination thereof in an amount of 25% to 45%, and
c. SPI, SPC, Ca Cas, or a combination thereof in an amount of about 25% to 45% by dry weight of the protein ingredients.

5. The food piece of claim 1, wherein the food piece comprises calcium carbonate in an amount of 0.1% to 4% by dry weight of the food piece and/or the oil comprises canola oil or corn oil.

6. (canceled)

7. The food piece of claim 1, wherein the food piece comprises one or a combination of additional protein ingredients in an amount of up to 40% by dry weight of the protein ingredients.

8. The food piece of claim 1, wherein the food piece comprises an additional ingredient in an amount of up to 15% by dry weight of the food piece.

9. The food piece of claim 1, wherein ingredients derived from grains are included in an amount of 0% to less than 15% by dry weight of the food piece.

10. (canceled)

11. The food piece of claim 1, wherein the food piece contains less than 5% by dry weight carbohydrate.

12. The food piece of claim 1, wherein the food piece contains no added carbohydrates.

13. A method of making a ready-to-eat flattened food piece having a crunchy texture and a protein content of at least 70% by dry weight of the food piece, the method comprising:
a. combining ingredients under extrusion conditions to make a composition having a protein content of at least 70% by dry weight, the ingredients including:
1) protein ingredients including a base protein blend comprising at least 60% by dry weight of the protein ingredients, the base protein blend consisting of:
i. sodium caseinate in an amount of about 10% to about 40% by dry weight of the protein ingredients;
ii. milk protein isolate, milk protein concentrate, or any combination thereof in an amount of about 20% to about 50% by dry weight of the protein ingredients; and
iii. legume protein isolate, legume protein concentrate, calcium caseinate, or a combination thereof in an amount of about 20% to 50% by dry weight of the protein ingredients;
2) oil in an amount of about 1% to about 8% by dry weight of the composition; and
3) water in an amount of about 20% to about 30% by weight of the composition;
the extrusion conditions comprising low shear, and a barrel temperature of about 160° F. to about 260° F.;
b. directing the composition through a die opening to make an extruded dough;
c. forming the extruded dough to produce a flattened dough; and
d. drying the flattened dough to a moisture content of about 0.5% to about 7% to produce the flattened food piece.

14. (canceled)

15. The method of claim 13, wherein extrusion conditions comprise a twin screw extruder with 2 reverse or high shear elements.

16. The method of claim 13, wherein extrusion conditions comprise a die pressure of about 600 psi to about 1500 psi.

17. The method of claim 16, wherein the die pressure is from about 650 psi to about 1400 psi.

18. The method of claim 13, wherein extrusion conditions comprise specific mechanical energy (SME) of about 40 W*h/kg to about 80 W*h/kg.

19. The method of claim 13, wherein extrusion conditions comprise a die temperature of about 200° F. to about 250° F.

20. The method of claim 13, wherein the forming step includes directing pieces of the extruded dough through a flaking mill to produce the flattened dough.

21. The method of claim 13, wherein the forming step includes forming the extruded dough into a continuous sheet and cutting the sheet to produce the flattened dough.

22. The method of claim 21, wherein the continuous sheet is a lattice.

23. The method of claim 21, wherein the continuous sheet is formed into shredded ropes.

24. The method of claim 21, wherein the continuous sheet is layered with at least one continuous sheet, and the layered sheets are cut into pieces.
